(19) United States
(12) Patent Application Publication
(10) Pub. No.: US 2013/0201700 A1
(43) Pub. Date: Aug. 8, 2013

(54) LAMP

(71) Applicants: Tetsushi Tamura, Osaka (JP); Kenji Takahashi, Osaka (JP); Yasushige Tomiyoshi, Osaka (JP); Nobuyuki Matsui, Osaka (JP); Shinya Sakumoto, Osaka (JP); Tomonari Hashimoto, Osaka (JP)

(72) Inventors: Tetsushi Tamura, Osaka (JP); Kenji Takahashi, Osaka (JP); Yasushige Tomiyoshi, Osaka (JP); Nobuyuki Matsui, Osaka (JP); Shinya Sakumoto, Osaka (JP); Tomonari Hashimoto, Osaka (JP)

(73) Assignee: PANASONIC CORPORATION, Kadoma-shi, Osaka (JP)

(21) Appl. No.: 13/877,197

(22) PCT Filed: Nov. 2, 2011
(86) PCT No.: PCT/JP2011/006153

§ 371 Date: Apr. 1, 2013

(30) Foreign Application Priority Data
Nov. 4, 2010 (JP) 2010-247328

(51) Int. Cl. F21V 29/00

(52) U.S. Cl. CPC F21V 29/22
USPC 362/382

(57) ABSTRACT

A lamp comprises a light emitting module including a substrate and LEDs mounted on the substrate, a heat sink that is cylindrical and that discharges heat produced during light emission by the LEDs, a base provided at one end of the heat sink, a mounting member having a front surface whereon the light emitting module is mounted, and a circuit unit positioned partially in the heat sink, receiving power through the base and causing the light emitting element to emit light. The mounting member is in contact with the heat sink so that the heat produced during light emission is transmitted to the heat sink. The circuit unit includes a circuit board and a plurality of electronic components mounted on the circuit board. The circuit board or at least one of the electronic components is thermally connected to the mounting member through a thermally conductive member.

### TECHNICAL FIELD

The present invention relates to a lamp that uses a light emitting element as a light source and that internally includes a circuit unit.

### BACKGROUND ART

In recent years, lamps that use LEDs (Light Emitting Diodes) have been proposed as an alternative to incandescent light bulbs, mini-krypton light bulbs, compact fluorescent lamps and the like (referred to below collectively as conventional lamps), which are used as light sources for lighting apparatuses. An LED is an example of a semiconductor light emitting element having a high lighting efficiency and long life. Lamps that use LEDs are referred to below as LED lamps in order to differentiate from conventional lamps.

An LED lamp may for example comprise: an LED module including a substrate and LEDs mounted thereon; a heat sink that is cylindrical and that discharges heat produced during LED light emission; a base provided at one end of the heat sink; a thermally conductive member that has a front surface whereon the LED module is mounted, that covers another end of the heat sink and that transmits heat produced during LED light emission to the heat sink; a circuit unit that receives power through the base and causes the LEDs to emit light; and a circuit housing member that houses the circuit unit, and that is positioned inside the heat sink (refer to Patent Literature 1 for example).

In the LED lamp described above, heat produced during LED light emission is transmitted to the heat sink through the thermally conductive member. A portion of the heat transmitted to the heat sink is discharged by convection and radiation, and a portion of the heat is transmitted away by conduction, passing through the base to the socket, and then to the lighting apparatus, ceiling and walls for example. The above prevents overheating of the LEDs in the LED module.

### CITATION LIST

### Patent Literature

### [Patent Literature 1]

International Publication No. 2010/090012

### [Patent Literature 2]

Japanese Patent Application Publication No. 2006-313718

### SUMMARY OF INVENTION

### Technical Problem

Through the configuration of the LED lamp described above, the heat from LEDs produced during LED light emission is transmitted away from the LEDs preventing overheating of the LEDs. Unfortunately, the above configuration is not able to prevent overheating of electronic components in the circuit unit.

The circuit unit includes a circuit board and the electronic components, and the circuit board is attached in a circuit case. The electronic components include electronic components which reach a high temperature during LED light emission (for example an integrated circuit). Consequently, there is carbonization of parts of the circuit board on which the high temperature electronic components are mounted, causing problems such as deterioration of insulating ability.

In recent years, there has particularly been demand for reduction in size of the heat sink and the circuit case housing the circuit unit, in order to allow reduction in size of the LED lamp. The above has an effect of increasing peripheral temperature of the circuit unit. Furthermore, in a circuit unit that allows dimming of an LED lamp, an increased number of electronic components are included in the circuit unit, thus causing increased peripheral temperature and temperature of the circuit unit.

The present invention aims to provide a lamp in which overheating of the circuit unit is prevented without need to increase the lamp in size.

### Solution to Problem

In order to solve the above problems, a lamp relating to the present invention comprises: a light emitting module including a substrate and a light emitting element mounted on the substrate; a heat sink that is cylindrical, and that discharges heat produced during light emission by the light emitting element; a base provided at one end of the heat sink; a mounting member having a front surface whereon the light emitting module is mounted; and a circuit unit positioned partially in the heat sink, receiving power through the base and causing the light emitting element to emit light, wherein the mounting member is in contact with the heat sink so that the heat produced during light emission is transmitted to the heat sink, the circuit unit includes a circuit board and a plurality of electronic components mounted on the circuit board, and the circuit board or at least one of the electronic components is thermally connected to the mounting member through a thermally conductive member.

### Advantageous Effects of Invention

In the lamp relating to the present invention, the circuit board or the at least one of the electronic components is thermally connected to the mounting member through the thermally conductive member. Therefore, heat is transmitted to the mounting member from the circuit board or the at least one of the electronic components, thus preventing accumulation of heat therein. The above prevents overheating of the circuit board or the at least one of the electronic components.

In another aspect of the present invention, the circuit unit may be housed in a circuit case positioned partially in the heat sink, the circuit board or the at least one of the electronic components may be thermally connected to an inner surface of the circuit case through a first thermally conductive member, and an outer surface of the circuit case may be thermally connected to a rear surface of the mounting member through a second thermally conductive member. In the above, housing may refer to the circuit case housing the circuit unit entirely or partially. Through the above configuration, heat produced or accumulated in the circuit board or the at least one of the electronic components can be efficiently conducted to the mounting member through the circuit case.

In another aspect of the present invention, the electronic components may include an integrated circuit which is mounted on a main surface of the circuit board that faces towards the mounting member, the at least one of the electronic components may be the integrated circuit, and the first thermally conductive member may be a silicone sheet. Through the above configuration, heat produced or accumulated in the integrated circuit, which is the at least one of the electronic components, can be efficiently conducted to the circuit case.

In another aspect of the present invention, a section of the front surface of the mounting member with the light emitting module mounted thereon, may be inclined relative to a central axis of the heat sink. Through the above configuration, even if the lamp is used in a lighting fixture for down-lighting, where the lamp is installed in a socket inclined relative to a central axis of a main body of the lighting fixture, light can be emitted in a downward direction from the main body of the lighting fixture.

In another aspect of the present invention, the circuit case may include a first case having a body part housed in the heat sink, and a base attachment part positioned at one end of the first case, the base attachment part protruding out of the one end of the heat sink and attaching to the base; and a second case covering another end of the first case, thermal conductivity of the second case may be higher than thermal conductivity of the first case, mechanical strength of the first case may be higher than mechanical strength of the second case, and the inner surface of the circuit case may be an inner surface of the second case. Through the above configuration, heat produced or accumulated in the circuit board or the at least one of the electronic components can be efficiently conducted from the circuit case to the mounting member. Furthermore, the first case can function as a structural part for attachment to the base.

In another aspect of the present invention, the thermal conductivity of the second case may fall in a range of 1 W/mK to 15 W/mK. Through the above configuration, heat produced or accumulated in the circuit board or the at least one of the electronic components can be efficiently conducted from the circuit case to the mounting member.

### BRIEF DESCRIPTION OF DRAWINGS

FIG. 1 is a cross-sectional diagram of a lighting apparatus relating to a first embodiment.

FIG. 2 is a perspective overview diagram of an LED lamp relating to the first embodiment.

FIG. 3 is a cross-sectional diagram of the LED lamp.

FIG. 4 is a broken-down perspective diagram of the LED lamp.

FIG. 5 is a broken-down perspective diagram of an upper section of the LED lamp.

FIG. 6 is a cross-sectional diagram of an LED lamp relating to a second embodiment.

### DESCRIPTION OF EMBODIMENTS

Embodiments of the present invention are described below with reference to the drawings as examples of lamps and lighting apparatuses relating to the present invention.

Materials and values in the embodiments are merely given as examples of preferable materials and values, and the present invention is not limited by the embodiments. The materials and values may be modified appropriately so long as there is no deviation from the technical scope of the present invention. Also, the embodiments may be combined in any way, so long as incompatibility does not arise between them.

### First Embodiment

### 1. Lighting Apparatus

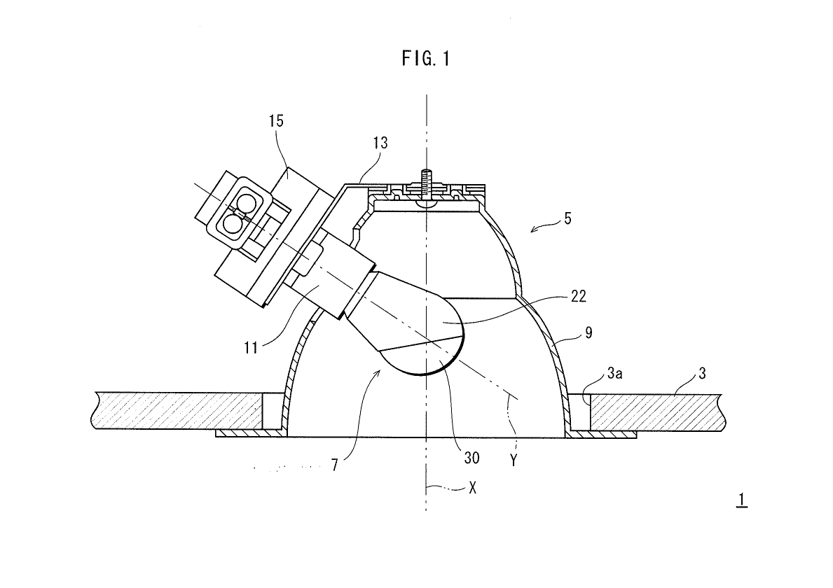

FIG. 1 is a cross-sectional diagram of a lighting apparatus 1 relating to a first embodiment.

The lighting apparatus 1 includes a lighting fixture 5 and an LED lamp 7 installed in the lighting fixture 5. The lighting fixture 5 is mounted into a ceiling 3 using an opening 3a provided therein. The LED lamp 7 is explained in detail further below.

The lighting fixture 5 is for down-lighting, and includes a fixture body 9 which is cup-shaped, a socket 11 for installing a lamp, a joining member 13 for joining the socket 11 to the fixture body 9 so as to be inclined at a predetermined angle relative to the fixture body 9, and a connecting unit 15 for connecting the lighting fixture 5 to commercial power. The socket 11 is suitable for installing the LED lamp 7 relating to the present invention and also conventional lamps such as incandescent light bulbs, mini-krypton light bulbs, and compact fluorescent lamps.

A central axis Y of the socket 11 (equivalent to a central axis of the LED lamp 7) is inclined relative to a central axis X of the fixture body 9 by a predetermined angle of inclination A. The angle of inclination A may for example be 70 degrees. When measuring the angle of inclination A of the socket 11, a point of intersection O of the central axis X and the central axis Y is taken as a vertex and the angle of inclination A is measured from a section of the central axis X extending above the point of intersection O.

### 2. LED Lamp

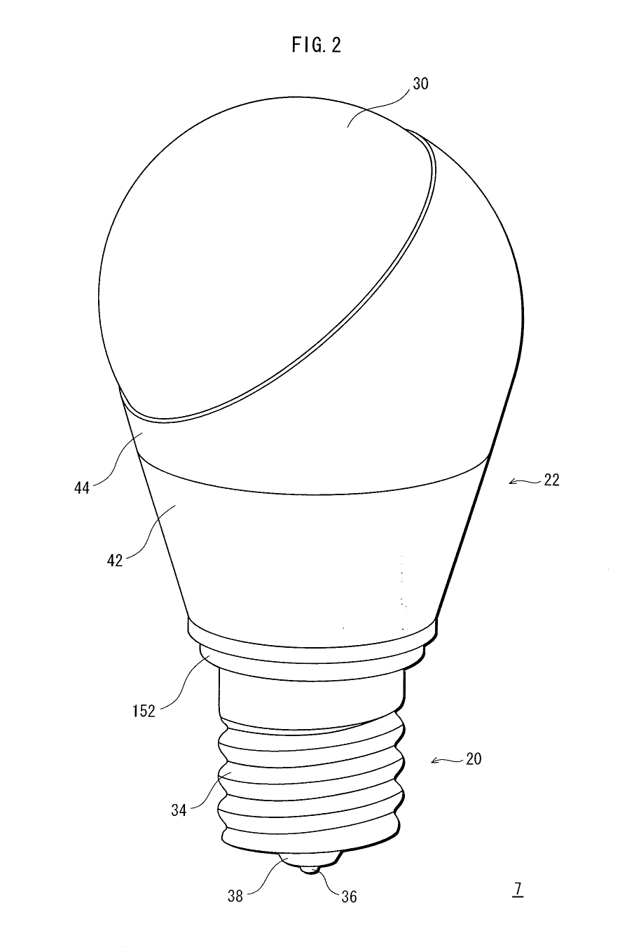

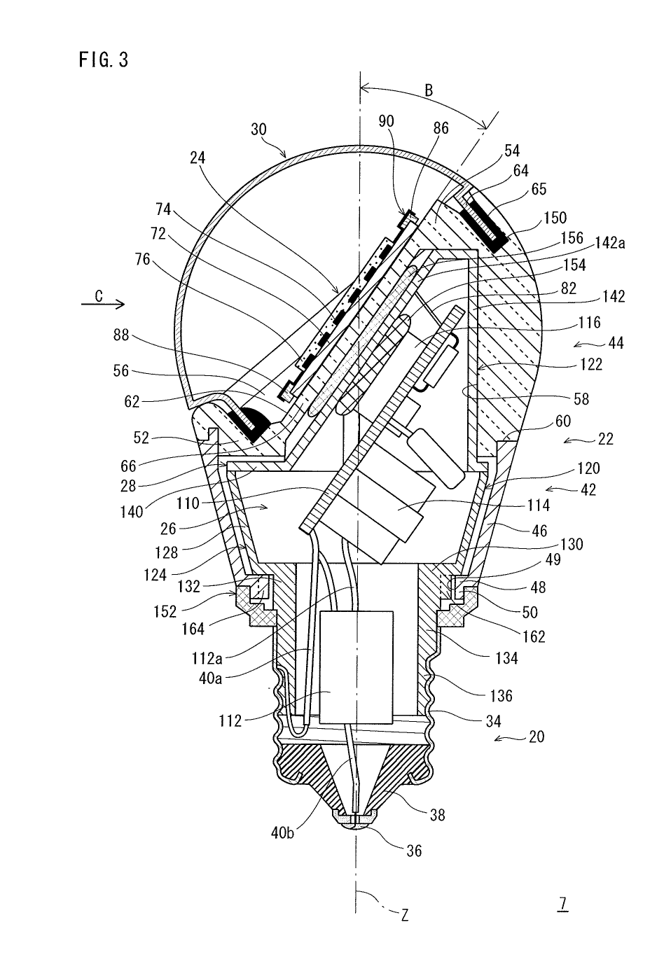

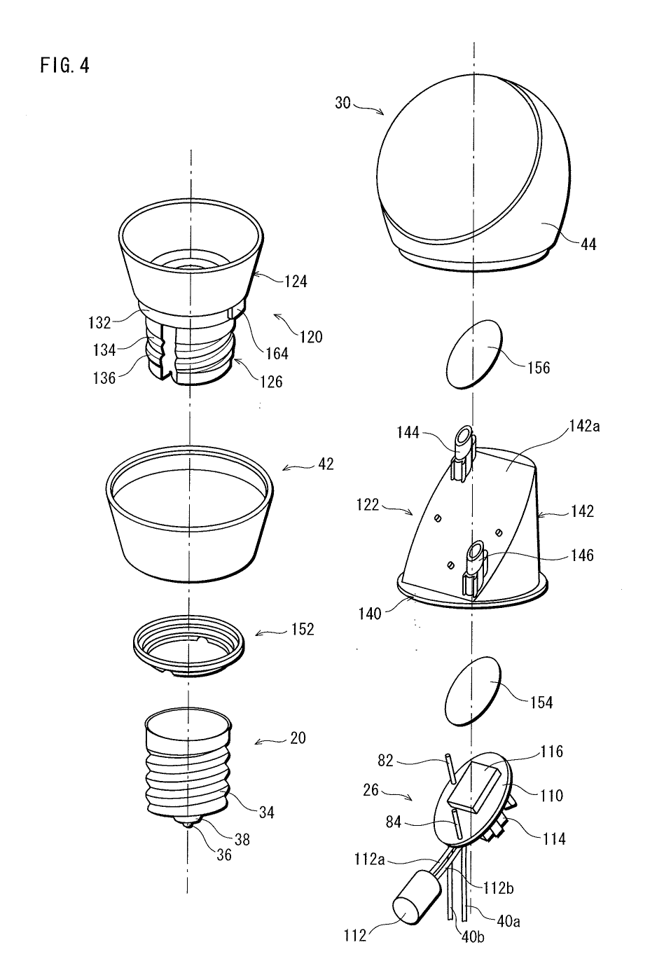

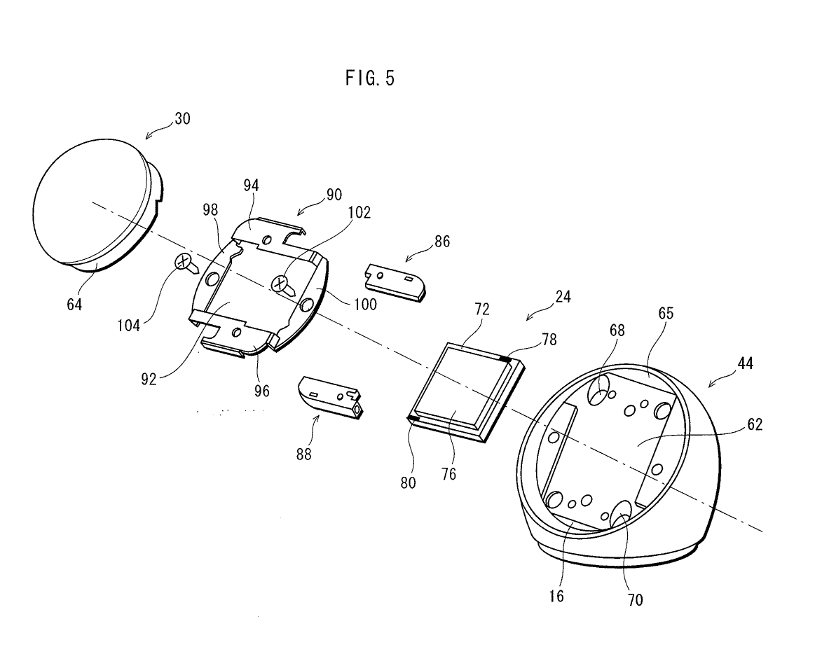

FIG. 2 is a perspective overview diagram of the LED lamp 7 relating to the first embodiment. FIG. 3 is a cross-sectional diagram of the LED lamp 7. FIG. 4 is a broken-down perspective diagram of the LED lamp 7. FIG. 5 is a broken-down perspective diagram of an upper section of the LED lamp 7.

Line Z in FIG. 3 is a lamp axis, the lamp axis being a central axis of the LED lamp 7 and a central axis of the base 20. When the LED lamp 7 is installed in the lighting fixture 5, line Z shown in FIG. 3 is equivalent to line Y shown in FIG. 1.

The LED lamp 7 includes a base 20 which can be simply installed in the socket 11 of the lighting fixture 5. The LED lamp 7 also includes a body 22 attached to the base 20, and rotatable relative to the base 20 around the central axis Z thereof. The body 22 includes a flat surface that is inclined relative to the central axis Z of the base 20 (LED lamp 7) by a predetermined angle B. The LED lamp 7 further includes an LED module 24 mounted on the flat surface of the body 22, a circuit unit 26 that causes the LED module 24 to emit light, a circuit case 28 that houses the circuit unit 26 and that is positioned in the body 22, and a globe 30 that covers the LED module 24.

In other words in the present embodiment, the LED lamp 7 is equivalent to the lamp relating to the present invention. The LED lamp 7 comprises: the LED module 24 including the mounting substrate 72 and the LEDs 74 mounted on the mounting substrate 72, equivalent to the light emitting module including the substrate and the light emitting element mounted on the substrate; the cylinder 42 that discharges heat produced during light emission by the LEDs 74, equivalent to the heat sink that is cylindrical, and that discharges heat produced during light emission by the light emitting element; the base 20 provided at one end of the cylinder 42, equivalent to the base provided at one end of the heat sink; the cover 44 having a front surface whereon the LED module 24 is mounted, equivalent to the mounting member having a front surface whereon the light emitting module is mounted; and a circuit unit 26 positioned partially in the cylinder 42, receiving power through the base 20 and causing the LEDs 74 to emit light, equivalent to the circuit unit positioned partially in the heat sink, receiving power through the base and causing the light emitting element to emit light.

(1) Base 20

As shown in FIGS. 2-4, the base 20 is the same as a base of a conventional lamp. Therefore, the LED lamp 7 is installable into any lighting fixture into which the conventional lamp is installable, such as the lighting fixture 5. For example the base 20 may be of an E type or a G type as set by Japanese Industrial Standards (JIS).

In the present embodiment the base 20 is of an E17 type. As shown in FIG. 3, a cylindrical shell 34 is connected to an eyelet 36, through an insulating connector 38. The shell 34 and the eyelet 36 are connected to the circuit unit 26 through wires 40a and 40b respectively. The base 20 is attached to a base attachment part 126 of the circuit case 28 by using a screw thread section of the shell 34 to thread with the base attachment part 126.

(2) Body 22

As shown in FIGS. 3 and 4, the body 22 includes a cylinder 42, which has an opening at each of two ends, and a cover 44 which is attached to one end of the cylinder 42 so as to cover the opening at the one end. The one end of the cylinder 42 referred to above is an end closest to the globe 30, and the other end of the cylinder 42 is an end closest to the base 20.

The cylinder 42 and the cover 44 may be attached for example by forcible insertion of the cover 44 into the cylinder 42, or by use of an adhesive. The body 22 can be rotated freely (up to a maximum of 360 degrees) relative to the base 20 through a mechanism which is described further below. The cylinder 42 and the cover 44 may alternatively be attached to one another using any other appropriate conventional art such as caulking, welding or screws.

(2.1) Cylinder 42

As shown in FIGS. 2-4, in a horizontal cross-section (perpendicular to the central axis Z) the cylinder 42 is ring shaped. Diameter of the cylinder 42 decreases with movement along the central axis Z from the one end of the cylinder 42 to the other end of the cylinder 42, hence the cylinder 42 has a conical shape. The cylinder 42 has an inclined section 46, which is inclined relative to the central axis Z so as to become increasingly close to the central axis Z with movement from the one end of the cylinder 42 to the other end of the cylinder 42, an extended section 48, which bends and extends towards the central axis Z at the other end of the cylinder 42, and a protruding section 50, which extends from the extended section 48 in a direction parallel to the axis Z, protruding away from the inclined section 46. The cylinder 42 is formed from a material with high thermal conductivity such as aluminum, and has a function of discharging heat.

The extended section 48 does not extend as far as the central axis Z of the cylinder 42. An opening 49 is formed by an inner circumferential edge of the extended section 48. The one end of the cylinder 42 has a larger diameter than the other end of the cylinder 42, therefore the one end and the other end may also be respectively referred to as a wide end and a narrow end.

(2.2) Cover 44

As shown in FIGS. 3 and 5, in terms of shape the cover 44 resembles a sphere which has had sections cut-away along two planes. The two planes are a first plane, which intersects perpendicularly with an imaginary line passing centrally through the sphere, and a second plane which is separated from the first plane and inclined relative to the imaginary line. The first plane and the second plane do not intersect with one another on an outer circumferential surface of the cover 44 which forms the external appearance thereof.

Cutting-away along the first plane forms a bottom part 52 which covers the one end of the cylinder 42. Cutting-away along the second plane forms an attachment part 54 which attaches to the globe 30.

In addition to the bottom part 52 and the attachment part 54, the cover 44 further includes a first recessed part 56 that recesses from the attachment part 54 (the second plane), a second recessed part 58 that recesses from centrally on the bottom part 52, and a stepped part 60 formed on an external circumferential edge of the bottom part 52 (the first plane). The cover 44 is formed from a material having high thermal conductivity such as aluminum.

The first recessed part 56 recesses so that, as shown in FIG. 3, a bottom surface 62 of the first recessed part 56 is inclined by an angle B relative to the central axis Z. In other words, the bottom surface 62 is inclined so that when viewed in a direction shown by arrow C in FIG. 3 (perpendicular to the central axis Z of the LED lamp 7), a lower section of the bottom surface 62 is closer to the viewer than an upper section of the bottom surface 62. The LED module 24 is mounted centrally on the bottom surface 62.

When viewed in the direction shown by arrow C in FIG. 3, the upper section of the bottom surface 62 protrudes above a plane on which an external circumferential edge of the attachment section 54 is positioned (i.e., the second plane), and the lower section of the bottom surface 62 recesses below the plane (the second plane).

The bottom surface 62 is inclined so that a section having the LED module 24 mounted thereon (a central section of the bottom surface 62), protrudes progressively further above the plane. Consequently, an attachment groove 65 is provided on an outer side (outer circumference) of a protruding section of the bottom surface 62 so as to allow attachment of a rim 64 at an open end of the globe 30.

As shown in FIG. 3, the second recessed part 58 has a shape and size corresponding to a section of the circuit case 28, thus allowing the section of the circuit case 28 to be inserted into the second recesses part 58. In terms of shape the second recessed part 58 is similar to a cylinder cut-away diagonally along a plane parallel to the bottom surface 62 of the first recessed part 56. When viewed in the direction shown by arrow C in FIG. 3, with increasing distance from the viewer, the second recessed part 58 recesses progressively deeper relative to a bottom surface (the first plane) of the bottom part 52.

Due to the shape of the second recessed part 58 described above, a base plate 66 positioned between the first recessed part 56 and the second recessed part 58 is of approximately constant thickness at a section where the LED module 24 is mounted. Through holes 68 and 70 are provided in the base plate 66 between the first recessed part 56 and the second recessed part 58, in order that wires 82 and 84 that electrically connect the LED module 24 and the circuit unit 26 can pass therethrough (refer to FIG. 5).

(3) LED Module 24

As shown in FIG. 3, the LED module 24 includes a mounting substrate 72 having a surface with a wiring pattern (omitted in the diagrams) thereon. The LED module 24 also includes a plurality of LEDs 74 that are mounted on the surface of the mounting substrate 72, and an encapsulating member 76 which encapsulates the LEDs 74.

FIG. 3 only shows six LEDs 74 in the LED module 24, but in the present embodiment a total of 36 LEDs 74 are encapsulated by the encapsulating member 76. The number of LEDs 74 is not limited to the above, and an appropriate number of LEDs may be decided for example based on lamp and LED specification.

The mounting substrate 72 is formed from an insulating material such as ceramic, and in the present embodiment is square in planar view. The wiring pattern of the mounting substrate 72 includes a connecting section for connecting the plurality of LEDs 74 mounted thereon in series, parallel or combination thereof, and terminals 78 and 80 for receiving power from the circuit unit 26 (refer to FIG. 5).

As shown in FIG. 5, the terminals 78 and 80 are respectively connected by terminal connection members 86 and 88 (refer to FIGS. 3 and 5) to wires 82 and 84 (refer to FIG. 4), that pass from inside to outside of the cover 44 through holes 68 and 70.

The encapsulating member 76 is for example formed from a transparent resin such as silicone resin. In a situation where wavelength conversion of light emitted by the LEDs 74 is necessary, a material capable of light wavelength conversion, such as a fluorescent powder, may be mixed into the transparent resin.

For example, emission of white light by the LED module 24 can be realized by using GaN type LEDs that emit blue light as the LEDs 74, and by using a mixture of a yellow-green fluorescent powder, such as (Ba,Sr)₂SiO₄:Eu²⁺ or YAG:Ce³⁺, and a red fluorescent powder, such as Sr₂Si₅N₈:Eu²⁺ or (Sr,Ca)AlSiN₃:Eu²⁺, as the fluorescent powder.

Alternatively, in a situation where wavelength conversion of light emitted by the LEDs 74 is necessary, a fluorescent film including a fluorescent powder may be formed on an inner circumferential surface of the globe 30.

A pressing plate 90 presses the LED module 24 against the bottom surface 62 of the first recessed part 56 in the cover 44, thus fixing the LED module 24 on the bottom surface 62. As shown in FIG. 5, the pressing plate 90 is larger than the LED module 24, and includes an opening 92 in a section corresponding to the encapsulating member 76 of the LED module 24. The pressing plate 90 has raised sections 94 and 96, which correspond to a pair of opposing sides of the LED module 24 respectively having the terminals 78 and 80 positioned thereat. The raised sections 94 and 96 are raised relative to non-raised sections 98 and 100 of the pressing plate 90, which correspond to a pair of opposing sides of the LED module 24 not having terminals positioned thereat. The terminal connection members 86 and 88 are positioned in gaps between the mounting substrate 72 of the LED module 24 and the raised sections 94 and 96 respectively of the pressing plate 90 (refer to FIG. 3).

In the configuration described above, when the pressing plate 90 is pressed against the LED module 24, the non-raised sections 98 and 100 of the pressing plate 90 are in contact with a front surface of the mounting substrate 72, and the raised sections 94 and 96 are in contact with upper surfaces of the terminal connection members 86 and 88 respectively. The non-raised sections 98 and 100 are attached to the cover 44 by threading of screws 104 and 102 respectively, and thus the LED module 24 is also attached to the cover 44.

The terminal connection members 86 and 88 include metal flat springs that connect to the wires 82 and 84 respectively. The flat springs of the terminal connection members 86 and 88 are respectively in contact with the terminals 78 and 80 on the mounting substrate 72 of the LED module 24. When the pressing plate 90 is attached to the cover 44 the flat springs are elastically deformed.

Alternatively, the LED module 24 may be fixed to the bottom surface 62 of the first recessed part 56 using an adhesive. In the above configuration, the LED module 24 can be tightly attached to the bottom surface 62 through use of the adhesive, therefore ensuring high efficiency of heat transmission to the cover 44. Further alternatively, the LED module 24 may be thermally connected to the bottom surface 62 using thermal grease.

(4) Circuit Unit 26

The circuit unit 26 causes the LEDs 74 to emit light using power supplied to the circuit unit 26 through the base 20. As shown in FIGS. 3 and 4, the circuit unit 26 includes a circuit board 110 and a plurality of electronic components mounted thereon. For example the circuit unit 26 may include a rectifier/smoothing circuit, a DC/DC converter, and a control circuit.

The plurality of electronic components may for example be an electrolytic capacitor 112 of the smoothing circuit, a choke coil 114 of the DC/DC convertor, and an IC 116 of the control circuit.

The IC 116 is mounted on one main surface of the circuit board 110 and the choke coil 114 and other electronic components are mounted on the other main surface of the circuit board 110. As described below in more detail, the electrolytic capacitor 112 is connected to the circuit board 110 by wires 112a and 112b, so that the electrolytic capacitor 112 can be positioned within the base 20.

As described above the circuit unit 26 is partially housed in the circuit case 28 which is positioned in the body 22. Attachment of the circuit unit 26 in the circuit case 28 is described further below.

(5) Circuit Case 28

As shown in FIGS. 3 and 4, the circuit case 28 includes a first case 120 and a second case 122. The first case 120 is housed mainly within the base 20 and the cylinder 42 of the body 22. The second case 122 is housed mainly within the cover 44 of the body 22. The first case 120 is freely rotatable relative to the second case 122.

(5.1) First Case 120

The first case 120 has a body part 124 which is housed within the cylinder 42, and a base attachment part 126 which attaches to the base 20. The base attachment part 126 protrudes out of the cylinder 42 at an end thereof closest to the base 20 (narrow end). As explained further below, the first case 120 is a structural element that functions with the base 20 to hold the cylinder 42 of the body 22, so as to be freely rotatable.

The body part 124 includes a cone section 128 that is cone-shaped, increasing in diameter with distance from the base 20 so as to correspond in terms of shape to an inner circumferential surface of the cylinder 42. The body part 124 also includes an extended section 130 that extends towards the central axis Z at an end of the body part 124 closest to the base 20. As shown in FIG. 3, an outer surface of the extended section 130, contacts with an inner surface of the extended section 48 of the cylinder 42. The other end of the body part 124, in other words an end furthest from the base 20, is covered by the second case 122.

The base attachment part 126 is cylindrical and extends towards the base 20 from the extended section 130 of the body part 124. The base attachment part 126 includes, in respective order from the body part 124, a first external diameter section 132 having an external diameter smaller than a maximum external diameter of the extended section 130 of the body part 124, a second external diameter section 134 having a smaller external diameter than the first external diameter section 132, and a screw section 136 having an external circumferential surface that is screw-shaped.

The first external diameter section 132 is has a smaller diameter than the opening 49 formed by the extended section 48 of the cylinder 42. The screw section 136 has a smaller external diameter than the second external diameter section 134. Through the above configuration, the base attachment part 126 is able to protrude out of the opening 49 at the narrow end of the cylinder 42.

The first case 120 is used as a structural element and thus is formed from a material having appropriate mechanical properties (strength and rigidity), for example a resin such as polybutylene terephthalate (PBT) (thermal conductivity 0.2 W/mK to 0.3 W/mK).

(5.2) Second Case 122

The second case 122 includes a base part 140 that is plate-shaped, and a housing part 142 which holds the circuit board 110 of the circuit unit 26 and partially houses the circuit unit 26. The second case 122 is freely rotatable relative to the base 20.

External appearance of the housing part 142 is similar to a cylinder which has been cut away diagonally leaving a small section of a top surface of the cylinder uncut. A sloped part 142a is formed at the diagonal cut.

The housing part 142 is of determined approximately uniform thickness, and hence an inner surface of the housing part 142 corresponds in terms of shape to an outer surface of the housing part 142 which forms the external appearance thereof. A housing space is formed by the inner surface, and the circuit unit 26 is partially housed within the housing space.

A fixing part, that fixes the circuit board 110 of the circuit unit 26, is formed on the inner surface of the housing part 142. More specifically, the circuit board 110 is fixed by a supporting protrusion that supports a rear surface (surface having the IC 116 mounted thereon) of the circuit board 110, and a locking claw that locks onto an edge of a front surface (surface having the choke coil 114 mounted thereon) of the circuit board 110.

As shown in FIG. 4, extended tubes 144 and 146 are formed on the sloped part 142a, protruding outwards therefrom. When the LED lamp 7 is assembled, the extended tubes 144 and 146 respectively insert into the through holes 68 and 70 in the cover 44. The wires 82 and 84, which electrically connect the LED module 24 to the circuit unit 26 inside of the second case 122, pass internally through the extended tubes 144 and 146 respectively.

As shown in FIG. 3, a rear surface of the sloped part 142a is thermally connected to the IC 116 through a silicone sheet 154. A front surface of the sloped part 142a is thermally connected to the cover 44 of the body 22 through a silicone sheet 156. Through the above configuration, the second case 122 achieves a function of conducting heat from the IC 116 to the body 22.

A function of the second case 122 is to conduct heat from the circuit unit 26 to the cover 44. Therefore, the second case 122 should be configured using a material with higher thermal conduction than both the first case 120 and air. For example, a resin may be used, such as PBT having thermally conductive filler (e.g. alumina filler) mixed therein (thermal conductivity 1 W/mK to 15 W/mK).

If both the first case 120 and the second case 122 are configured using a resin as the main material, thermal conductivity can be adjusted by changing the amount of filler mixed into the resin. Increasing the amount of filler mixed into the resin increases the thermal conductivity of a case configured therefrom, while reducing the amount of filler mixed into the resin increases the mechanical properties of a case configured therefrom.

(6) Globe 30

The globe 30 may for example be hemispheric in shape, and in terms of external appearance is similar in part to a bulb part (glass part) of a mini-krypton light bulb. In other words, when the globe 30 is attached to the cover 44, the globe 30 and the cover 44 are similar in shape to a bulb part of an incandescent light bulb. The globe 30 is attached to the body 22 so as to cover the LED module 24.

As shown in FIGS. 1 and 2, the globe 30 is attached to the body 22 so that a plane on which a circumferential edge at an open end of the globe 30 is positioned is inclined relative to the central axis of the LED lamp 7.

The globe 30 has a rim 64 at the open end thereof, the rim 64 being inserted into the first recessed part 56 or the attachment groove 65 and fixed by an adhesive applied therein.

(7) Joining Ring 152

The joining ring 152 functions with the circuit case 28 (the first case 120) to hold the cylinder 42 of the body 22 so as to be freely rotatable relative to the base 20, which is attached to the base attachment part 126. The joining ring 152 has an inner circumferential surface that corresponds in terms of shape with the narrow end of the cylinder 42. Specifically, the narrow end of the cylinder 42 has a stepped shape, and thus the inner circumferential surface of the joining ring 152 also has a stepped shape.

The inner circumferential surface of the joining ring 152 has a two-stepped shape. A first tread part, which is closest to the cylinder 42, of the inner circumferential surface of the joining ring 152, contacts with a riser part at the narrow end of the cylinder 42. A third tread part of the inner circumferential surface of the joining ring 152 contacts with a riser part between the first external diameter section 132 and the second external diameter section 134 of the base attachment part 126. A most inner circumferential surface of the joining ring 152 contacts with the external circumferential surface of the first external diameter section 132 to a degree which does not hinder relative rotation thereof (position is determined by the above).

The above configuration ensures that the cylinder 42 is not held to the circuit case 28 too loosely.

The joining ring 152 is attached to the circuit case 28 so that the base 20 is attached to the base attachment part 126 with the joining ring 152 in contact with an end surface at one end of the base 20.

### 3. Rotation Regulation Mechanism

In the present embodiment, a rotation regulation mechanism is provided which regulates rotation of the body 22 relative to the base 20 to less than 360 degrees. The circuit unit 26 rotates in accordance with rotation of the body 22, and because the circuit unit 26 is connected to the base 20 through the wires 40a and 40b, rotation of the body 22 can cause the wires 40a and 40b to rupture or separate from the base 20. The rotation regulation mechanism is provided in order to prevent the above. Furthermore, when installing the LED lamp 7 into the socket 11 by screwing while gripping the globe 30 or the cover 44, the rotation regulation mechanism prevents redundant rotation of the globe 30 or the cover 44 relative to the base 20.

In the rotation regulation mechanism, an engaging part is provided on the circuit case 28 and an engagement receiving part is provided on the cylinder 42. The engaging part and the engagement receiving part engage with one another at a predetermined rotational position when the cylinder 42 (the body 22) is rotated relative to the base 20 (the circuit case 28). Alternatively, the engaging part may be provided on the cylinder and the engagement receiving part may be provided on the circuit case. Further alternatively, the circuit case may be held freely rotatable relative to the base by attaching the circuit case to the base through a screw positioned on the central axis of the circuit case and the base, the circuit case being freely rotatable relative to the screw.

Specifically, in the first case 120 a protrusion 162 is provided at a position on the first external diameter section 132 that opposes the inner circumferential surface of the opening 49 in the cylinder 42. The protrusion 162 protrudes towards the opening 49, contacting with the inner circumferential surface thereof. Also, a protrusion 164 is provided at a position on the inner circumferential surface of the opening 49 that opposes the first external diameter section 132 of the first case 120. The protrusion 164 protrudes towards the central axis Z of the cylinder 42.

In the above configuration, the protrusion 164 of the cylinder 42 is in contact with the outer circumferential surface of the first external diameter section 132 of the first case 120, and when the cylinder 42 is rotated in the above state, eventually the protrusion 162 on the first external diameter section 132 comes into contact (engagement) with the protrusion 164 of the cylinder 42, and thus further rotation is prevented.

In the above explanation the body 22 is freely rotatable relative to the base 20. Alternatively the cover (44), which is a configuration element of the body 22, may be attached to the cylinder (42) so as to be freely rotatable relative thereto.

### 4. Assembly

One example of assembly of the LED lamp is explained below. The order of assembly explained below is just one example thereof, and the LED lamp may alternatively be assembled in a different order.

(1) Assembly of the Second Case 122 into the Cover 44 (Refer to FIG. 4)

The second case 122 is assembled into the cover 44. Before assembling the second case 122 into the cover 44 the silicone sheet 156 is placed on the sloped part 142a of the second case 122. The second case 122 is assembled into the cover 44 by forcible insertion of the extended tubes 144 and 146 of the second case 122 into the through holes 68 and 70 respectively of the cover 44.

Distance between the sloped part 142a of the second case 122 and the base plate 66 of the cover 44 is designed so that when the second case 122 is assembled into the cover 44, the silicone sheet 156 is in contact with both the sloped part 142a and the base plate 66.

(2) Assembly of the Circuit Unit 26 into the Second Case 122 (Refer to FIG. 4)

The circuit unit 26 is inserted into the second case 122. An end of the circuit unit 26, opposite to an end at which the electrolytic capacitor 112 is positioned, is inserted into the second case 122 first. When the circuit unit 26 is inserted, a surface of the circuit board 110 that is facing the sloped part 142a is the surface having the IC 116 mounted thereon. The circuit unit 26 is inserted into the second case 122 so that the circuit board 110 is parallel to the sloped part 142a. When inserting the circuit unit 26 into the second case 122, the wires 82 and 84, which electrically connect the LED module 24 to the circuit unit 26, are guided respectively through the extended tubes 144 and 146 of the second case 122, and out of the through holes 68 and 70 in the cover 44.

When a leading edge, in terms insertion direction, of the circuit board 110 contacts with the second case 122, the circuit board 110 is pressed towards the sloped part 142a, and the circuit unit 26 is fixed to the second case 122 by the fixing part.

Before inserting the circuit unit 26 into the second case 122, the silicone sheet 156 is attached to an upper surface (surface facing the sloped part 142a) of the IC 116. Through the above configuration, once the circuit unit 26 is assembled into the second case 122, the sloped part 142a and the IC 116 are thermally connected.

Once the circuit board 110 is attached in the second case 122, as shown in FIG. 3 the electrolytic capacitor 112, the choke coil 114 and a part of the circuit board 110 protrude out of the second case 122.

(3) Attachment of the First Case 120 and the Cylinder 42 to the Second Case 122 (Refer to FIG. 4)

The electrolytic capacitor 112, the choke coil 114 and the part of the circuit board 110 that protrude out of the second case 122 are inserted into the first case 120, and the base part 140 of the second case 122 is used to cover the opening in the first case 120 like a lid. The above completes assembly of the circuit case 28, housing the circuit unit 26 therein.

Subsequently, the first case 120 of the circuit case 28 is inserted into the cylinder 42 so that the base attachment part 126 of first case 120 protrudes out of the opening at the narrow end of the cylinder 42.

(4) Attachment of the Cover 44 to the Cylinder 42 (Refer to FIG. 4)

The cover 44 is attached to the cylinder 42. Specifically, the bottom part 52 of the cover 44 is forcibly inserted into an opening at the wide end of the cylinder 42. In other words, the stepped part 60 of the cover 44 is aligned with the opening at the wide end of the cylinder 42, and subsequently the cover 44 is pressed towards the cylinder 42.

The above completes, assembly of the body 22 containing the circuit case 28, which houses the circuit unit 26 therein.

(5) Attachment of the LED Module 24 and the Globe 30 to the Body 22 (Refer to FIG. 5)

The wires 82 and 84, which respectively extend out of the through holes 68 and 70 in the body 22, are respectively connected to connection terminal members 86 and 88. Subsequently, the LED module 24 is mounted centrally on the bottom surface 62 of the cover 44 of the body 22.

With flat springs of the connection terminal members 86 and 88 respectively connected to terminals 78 and 80 of the LED module 24, the pressing plate 90 is placed over the LED module 24 so that the encapsulating member 76 of the LED module 24 fits into the opening 92 in the pressing plate 90. Once in the above position the pressing plate 90 is fixed to the cover 44 by the screws 102 and 104.

Adhesive 150 is applied in the attachment groove 65 and a part of the first recessed part 56. Subsequently, the rim 64 at the opening in the globe 30 is inserted into the attachment groove 65 and the first recessed part 56, thus fixing the globe 30 to the body 22.

(6) Attachment of the Base 20 to the Circuit Case 28 (Refer to FIG. 4)

After fitting the joining ring 152 onto the base attachment part 126 of the circuit case 28, the wire 40a, which connects the circuit unit 26 to the shell 34, is bent along an outer circumference of the base attachment part 126, and the wire 40b is guided out of a through hole in the eyelet 36.

The screw part 136 on the outer circumference of the base attachment part 126 is threaded into the screw part on the shell 34 of the base 20. A root part (a part at an end closest to the joining ring 152) of the shell 34 is caulked with the cylinder 42 held freely rotatably by the circuit case 28 and the joining ring 152.

Finally, the wire 40b is soldered to the eyelet 36, thus completing assembly of the LED lamp 7.

### 5. Thermal Conduction

Thermal conduction from the circuit unit 26 when causing the LED lamp 7 to emit light is explained below.

The circuit unit 26 receives power through the base 20, and power is supplied to the LED module 24 through a circuit configuring the circuit unit 26.

When power is supplied as described above the electronic components such as the IC 116 increase in temperature. Temperature of the IC 116 may become greater than temperature of the LED module 24. When the above occurs, heat is transmitted from the IC 116 to the circuit case 28 (the second case 122) through the silicone sheet 154. Heat transmitted to the circuit case 28 is transmitted to the cover 44 of the body 22 through the silicone sheet 156.

A portion of heat transmitted to the cover 44 is discharged into the surrounding air due to the radiating function of the cylinder 42. The rest of the heat transmitted to the cover 44 is discharged by transmission to the lighting fixture 5 through the base 20.

The above ensures that heat does not accumulate in the IC 116, thus preventing overheating of the IC 116.

### Second Embodiment

In the first embodiment the LED module 24 is mounted in the body 22 so as to be inclined relative to the central axis Z of the lamp. A second embodiment where an LED module is mounted so as to be perpendicular to a central axis Z of a lamp is explained below.

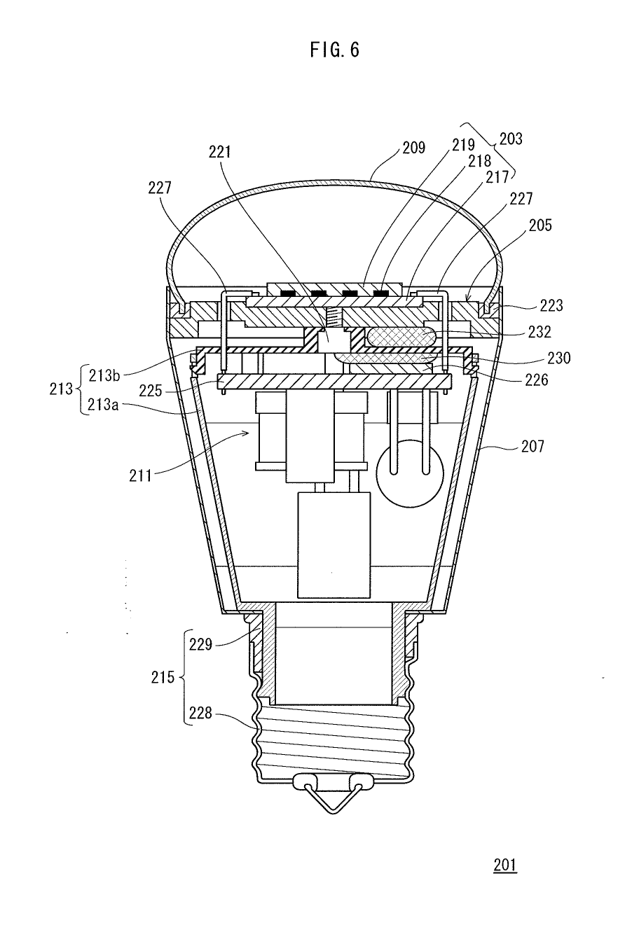

FIG. 6 is a cross-sectional diagram of an LED lamp 201 relating to the second embodiment.

The LED lamp 201 includes an LED module 203 having a plurality of LEDs 218 as a light source, a mounting member 205 having the LED module 203 mounted thereon, a case 207 having the mounting member 205 attached at one end thereof, a globe 209 that covers the LED module 203, a circuit unit 211 that causes the LEDs 218 to emit light, a circuit case 213 that is positioned in the case 207 and that houses the circuit unit 211 therein, and a base 215 provided at the other end of the case 207.

A combination of the case 207 and the mounting member 205 is equivalent to the body 22 in the first embodiment.

As in the first embodiment, the LED module 203 includes a mounting substrate 217, the LEDs 218, and an encapsulating member 219. The encapsulating member 219 is formed from a transparent material having a light wavelength converting material mixed therein.

The mounting member 205 is formed from a plate-shaped material and has a front surface with the LED module 203 mounted thereon. The mounting member 205 covers the one end of the case 207. The mounting member 205 has a function of transmitting heat produced during light emission by the LEDs 218 to the case 207. Therefore, the mounting member 205 is formed from a material having high thermal conductivity, such as aluminum.

In the second embodiment, the mounting member 205 is formed from the plate-shaped material, and is forcibly inserted into the one end of the case 207. Also, the mounting member 205 is attached to the circuit case 213 by a screw 221. The mounting member 205 has a stepped part on an outer circumferential surface thereof. A rim at an open end of a globe 209 is inserted into a groove that is formed between the one end of the case 207 and the stepped part of the mounting member 205. The rim of the globe 209 is fixed in the groove using an adhesive 223.

The case 207 is cylindrical, and has the mounting member 205 attached at the one end and the base 215 attached at the other end. The case 207 has a function of radiating heat produced by the LEDs 218 during light emission, after the heat is transmitted to the case 207 through the mounting member 205. Therefore, the case 207 is formed from a material having high thermal radiation efficiency, such as aluminum.

A body of the circuit case 213 is housed within the case 207, but part of the circuit case 213 protrudes out of the other end of the case 207. The base 215 is attached to the part of the circuit case 213 that protrudes out of the case 207.

The globe 209 is inserted into the groove formed when the mounting member 205 and the case 207 are assembled together. The adhesive 223 is applied in the groove, thus fixing the globe 209 to the mounting member 205 and the case 207.

The circuit unit 211 includes a circuit board 225 and a plurality of electronic components mounted thereon, and is housed in the circuit case 213. The circuit unit 211 and the LED module 203 are electrically connected by wires 227. The electronic components include an IC 226 that is mounted on a main surface of the circuit board 225, which is a surface closest to the mounting member 205.

The circuit case 213 has a body 213a and cover 213b, each of which is configured using an electrically insulating material. For example the electrically insulating material may be a synthetic resin such as PBT. The IC 226 is thermally connected to the cover 213b through a silicone sheet 230.

The cover 213b has a function of conducting heat from the circuit unit 211 to the mounting member 205; therefore the cover 213b is formed from a material with high thermal conductivity. The body 213a may be formed using the same material as the cover 213b, or alternatively the body 213a may be formed using a material with strong mechanical properties, in the same way as described for the first case 120 in the first embodiment.

Part of an outer surface of the cover 213b is thermally connected to a rear surface of the mounting member 205 through a silicone sheet 232. The part of the outer surface of the cover 213b corresponds in terms of position to a part of the inner surface of the cover 213b which is thermally connected to the IC 226 through the silicone sheet 230.

The base 215 is of an Edison-type, and has a bottom part 228 and an insulating part 229, which ensures electrical insulation of the bottom part 228 from the case 207.

### Modified Examples

### 1. Circuit Case

In the embodiments the circuit unit 26, 211 is housed in the circuit case 28, 213, but alternatively the circuit unit 26, 211 may be housed in the body or the case without being housed in the circuit case. In the above configuration, the circuit unit may be attached to the cover using a locking structure, a screw structure, an adhesive, or the like.

In the circuit case 28 relating to the first embodiment, the first case 120 and the second case 122 are formed from different materials, the materials differing in terms of mechanical properties and thermal conductivity. In contrast to the above, in the circuit case 213 relating to the second embodiment, no specific limitation is given for the material used to form the body 213a.

In the first embodiment the LED lamp 7 is configured so that the body 22 is freely rotatable relative to base 20 up to 360 degrees, and the first case 120 bears any load that arises when the LED lamp 7 is installed in the socket 7. Consequently, the first case 120 is required to have strong mechanical properties (e.g. strength, elasticity and ductility), and thus the material used to form the second case 122 (a material having filler mixed in) is fragile and therefore unsuitable. In contrast to the above, in the second embodiment the case 207 is not rotatable relative to the base 215, therefore it is not necessary for the body 213a relating to the second embodiment to have mechanical properties as strong as the first case 120 relating to the first embodiment.

Furthermore, in the first embodiment in a configuration where it is not necessary for the first case to have strong mechanical properties (for example where the cylinder is attached to the base so that the cover and the cylinder are freely rotatable), by forming the first case from an ordinary material (for example a resin material containing little or no filler), costs can be reduced. Likewise in the second embodiment, by forming the case body 213a from an ordinary material costs can be reduced.

In a configuration where the first case 120 or the case body 213a is not attached to the base, the first case or the case body may be entirely omitted from the circuit case.

In the first embodiments the circuit case 28, 213 is thermally connected to the mounting member 44, 205 using the thermally conductive member 156, 232. Alternatively, the circuit case may be attached to the mounting member in direct contact therewith, or in contact via thermal grease.

### 2. Electronic Components

In the first embodiment for example, the IC 116 is thermally connected to the cover 44 through the silicone sheets 154 and 156. In the embodiments, only an electronic component thought most likely to reach high temperature during light emission is thermally connected. However, thermal connection is not limited only to the electronic component thought most likely to reach high temperature. Other electronic components may also be thermally connected, for example an electronic component that might reach a temperature close to a thermal destruction temperature thereof during light emission, or an electronic component that might reach a temperature during light emission that would affect an adjacent electronic component by causing thermal destruction thereof.

Alternatively the circuit board may be thermally connected instead of the electronic components. For example, thermal connection may be of a section of the circuit board on which an electronic component predicted to reach a high temperature during light emission is mounted, or thermal connection may be of a section of the circuit board on which an electronic component with a low heat resistant temperature is mounted.

In the embodiments, an electronic component predicted to reach a high temperature is thermally connected to a mounting member (the cover 44 or the mounting member 205) by a material (the silicone sheet) having higher thermal conductivity than air. Alternatively, the electronic component may be thermally connected to a heat radiating member (the cylinder 42, the case 207 or the circuit case 28). For example, if the electronic component is thermally connected to the circuit case, which has a larger heat capacity than the electronic component and the circuit board, heat is conducted towards the circuit case, thus preventing overheating of the electronic component and the circuit board.

### 3. Thermally Conductive Member

In the embodiments, the thermally conductive member is realized by the silicone sheets 154, 156, 230, 232. As described above, each of the silicone sheets is formed by mixing a filler having high thermal conductivity, such as alumina filler, into silicone resin. Thermal conductivity of the silicone sheet is determined by filler content thereof.

In consideration of conduction of heat to the mounting member from the electronic components and the circuit board in the circuit unit, preferably the thermally conductive member should have thermal conductivity on a similar scale to the circuit case (the second case 122 or the cover 213b).

In other words, since the thermal conductivity of the second case 122 is 1 W/mK to 15 W/mK, preferably thermal conductivity of the thermally conductive member should also be 1 W/mK to 15 W/mK. However, in some cases it may not be possible to achieve thermal conductivity of 1 W/mK to 15 W/mK by varying the material used as the filler or the amount of the filler. For example for a silicone sheet, when also taking into consideration operability, adhesiveness and malleability of the sheet, thermal conductivity of the sheet should be 1 W/mK to 10 W/mK.

In the embodiments the thermally conductive member is configured using the silicone sheets 154, 156, 230, 232, but alternatively the thermally conductive member may be configured in a different form.

In a different configuration of the thermally conductive member, silicone resin may be used to thermally connect a plurality of different configuration elements. For example electronic components and the circuit case may be thermally connected. The above configuration could be achieved by injecting silicone resin that subsequently hardens into a connecting section (a gap between two configuration elements) once the two configuration elements have been assembled.

Alternatively, a material other than a silicone material may be used for the thermally conductive member, although obviously the material should preferably have high thermal conductivity.

### 4. Mounting Member

No specific explanation was given of the surface of the cover 44 in the first embodiment, or of the mounting member 205 in the second embodiment. Various modifications may be performed on the surface. For example an insulating layer may be formed on a mounting surface for the LED module through alumite treatment or coating. The insulating film increases the voltage which the lamp is able to withstand. Alternatively, a reflective film may be formed on the mounting member. The reflective film causes reflection towards the globe of light emitted by the LEDs, thus improving light emission efficiency of the lamp.

Further alternatively, either of the films described above may be formed on the pressing plate 90.

### INDUSTRIAL APPLICABILITY

The lamp in the present invention may be used as a substitute for a conventional lamp such as an incandescent light bulb, a mini-krypton light bulb, or a compact fluorescent lamp.

### REFERENCE SIGNS LIST

7, 201 LED lamp (lamp)
20, 228 base
24, 203 LED module
28, 211 circuit unit
30 globe
44 cover (mounting member)
46 cylinder (heat sink)
72, 217 mounting substrate
110, 225 circuit board
116, 226 electronic component
205 mounting member
207 case (heat sink)

1-6. (canceled)

7. A lamp, comprising:
a light emitting module including a substrate and a light emitting element mounted on the substrate;
a heat sink that is cylindrical, and that discharges heat produced during light emission by the light emitting element;
a base provided at one end of the heat sink;
a mounting member having a front surface whereon the light emitting module is mounted;
a circuit unit receiving power through the base and causing the light emitting element to emit light; and
a circuit case positioned partially in the heat sink, and housing the circuit unit therein, wherein
the mounting member is in contact with the heat sink so that the heat produced during light emission is transmitted to the heat sink,
the circuit unit includes a circuit board and a plurality of electronic components mounted on the circuit board,
the circuit board or at least one of the electronic components is thermally connected to the mounting member through a thermally conductive member,
the circuit case includes:
a first case having a body part housed in the heat sink, and a base attachment part positioned at one end of the first case, the base attachment part protruding out of the one end of the heat sink and attaching to the base; and
a second case covering another end of the first case, and
mechanical strength of the first case is higher than mechanical strength of the second case.

8. The lamp in claim 7, wherein
the circuit board or the at least one of the electronic components is thermally connected to an inner surface of the second case through a first thermally conductive member, and
an outer surface of the circuit case is thermally connected to a rear surface of the mounting member through a second thermally conductive member.

9. The lamp in claim 8, wherein
the electronic components include an integrated circuit which is mounted on a main surface of the circuit board that faces towards the mounting member,
the at least one of the electronic components is the integrated circuit, and
the first thermally conductive member is a silicone sheet.

10. The lamp in claim 7, wherein
a section of the front surface of the mounting member with the light emitting module mounted thereon, is inclined relative to a central axis of the heat sink.

11. The lamp in claim 7, wherein
thermal conductivity of the second case is higher than thermal conductivity of the first case, and
the thermal conductivity of the second case falls in a range of 1 W/mK to 15 W/mK.

12. The lamp in claim 9, wherein
thermal conductivity of the second case is higher than thermal conductivity of the first case, and
the thermal conductivity of the second case falls in a range of 1 W/mK to 15 W/mK.

13. The lamp in claim 10, wherein
thermal conductivity of the second case is higher than thermal conductivity of the first case, and
the thermal conductivity of the second case falls in a range of 1 W/mK to 15 W/mK.
